(19) United States
(12) Patent Application Publication
(10) Pub. No.: US 2023/0409624 A1
(43) Pub. Date: Dec. 21, 2023

(54) MULTI-MODAL HIERARCHICAL SEMANTIC SEARCH ENGINE

(71) Applicant: Hewlett-Packard Development Company, L.P., Spring, TX (US)

(72) Inventors: Thomas da Silva Paula, Porto Alegre (BR); Juliano Cardoso Vacaro, Porto Alegre (BR); Wagston Tassoni Staehler, Porto Alegre (BR); David Murphy, Palo Alto, CA (US)

(73) Assignee: Hewlett-Packard Development Company, L.P., Spring, TX (US)

(21) Appl. No.: 18/250,519

(22) PCT Filed: Oct. 30, 2020
(86) PCT No.: PCT/US2020/058179

§ 371 Date: Apr. 25, 2023

(51) Int. Cl. G06F 16/383; G06F 16/583; G06F 40/205

(52) U.S. Cl. CPC G06F 16/383; G06F 16/583; G06F 40/205

(57) ABSTRACT

Systems, methods, and corresponding computer-readable media for multi-modal hierarchical semantic search of electronic documents. Systems in accordance with the disclosure comprise search engine controllers, any desired numbers of search engine interface controllers, and persistent data stores accessible by the search engine controllers. The controllers are configured to parse searchable document data sets to extract document object data sets. Each document object data set can represent textual and/or image feature of the document. For each document object data sets the controller generates at least one enriched document object data set, and forms at least one of a document graph or index. In response to search requests, the search controller compares document graphs or indexes to identify the most similar documents.

### BACKGROUND

The disclosure relates to search engines and methods of searching electronic documents and other electronic information structures based on text, images, and/or other document features, and information associated with document features.

### BRIEF DESCRIPTION OF THE DRAWINGS

Various aspects and examples of the disclosure are illustrated in the accompanying drawings, which are meant to be not limiting, and in which like references are intended to refer to like or corresponding parts.

FIG. 1 is a schematic diagram showing examples of possible functional relationships between components of an example hierarchical search system in accordance with various aspects and examples of the disclosure.

FIGS. 2 through 9 are schematic diagrams illustrating examples of logical process flows as implemented by search engines in accordance with various aspects and examples of the disclosure.

FIGS. 10 and 11A and 11B are schematic diagrams illustrating examples of controller interfaces useful in implementing various aspects and examples of the disclosure.

### DETAILED DESCRIPTION

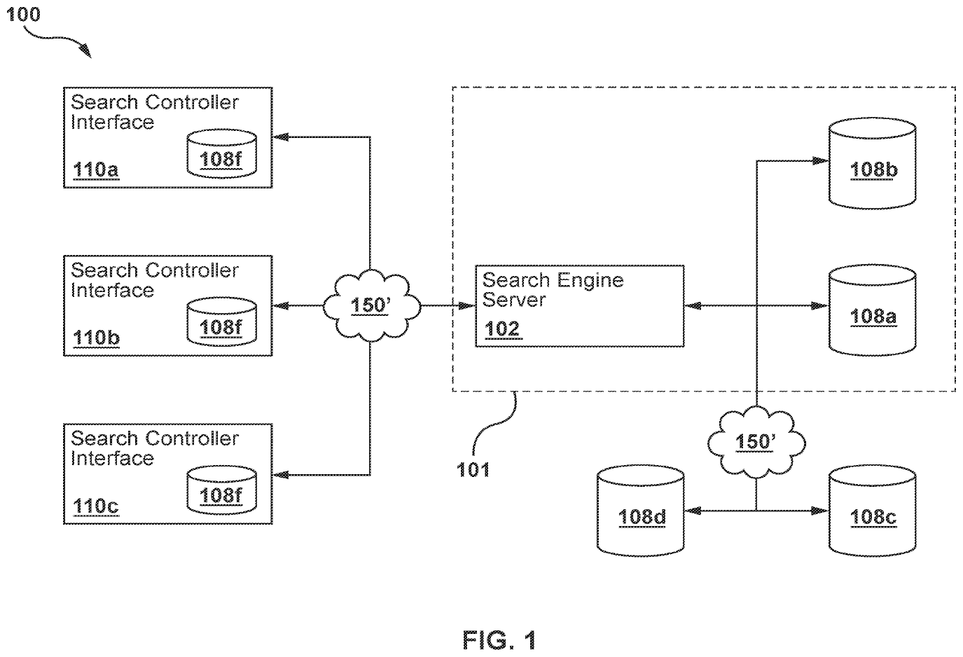

This disclosure pertains to hierarchical search mechanisms employing feature vectors and other representations of content extracted from electronic documents, and use of such representations to generate efficiently-searchable data structures, such as document graphs, to enable identification of content that that is semantically similar to images, text, or other data objects associated with other electronic documents. For example, a hierarchical search mechanism such as the search engine 102 of a search system 100 shown in FIG. 1 can perform hierarchical searches of electronic documents and/or other machine-readable information sets in stored database(s) 108 upon receipt of signals representing suitably-configured search requests from search controller interfaces 110.

Both within and outside of large organizations, it is often useful to search electronic information structures such as electronic documents for data sets containing or otherwise relating to some or all of text strings, images, and other document features. The disclosure pertains to hierarchical search mechanisms employing the use of feature vectors and other information representations, which can be used to generate efficiently-searchable feature-hierarchy documents, which can include graphs, indexes, levels, or other hierarchical representations of relationships between objects or features within parsed documents. For example, the disclosure enables the use of rich search representations which can be learned by deep neural networks, which enables the finding of content that that is semantically similar to images, text, or complete documents or document fragments.

In this disclosure, the term ‘document’ or ‘electronic document,’ unless otherwise required or implied by context, refers to any searchable electronic data or information set, or portion thereof, comprising data representing any text, image, video, audio, or other type of information.

Search engines/servers 102, search controllers 110, and electronic document databases 108 of search systems 100 can, in accordance with various aspects of the disclosure, be provided in any of a very wide variety of types and configurations. For example, as will be understood by those skilled in the relevant arts, once they have been made familiar with this disclosure, systems 100 can be provided in the form of internally-networked enterprise systems, such as might be used by a corporation or other business entity, with search controllers 110 being provided in the form of secure enterprise terminals and databases 108 in the form of secure data stores of any desired type(s), connected for secure communications by enterprise network(s) 150′. As a further example, a search engine 101 can be provided in the form of a host or server on a wide-area network 150 such as the internet, with search controller interfaces taking the form of personal network communications devices such as desktop or table computers, smart phones, or other mobile devices, etc. Optionally, datastores 108a,b can be provided in the form of secure datasets associated with such a host or server 101, while data sets 108c,d can be provided in the form of independent networked information sources of any desired types. A very wide variety of architectures 100 are contemplated and are both consistent with and suitable for configuration in accordance with the disclosure herein.

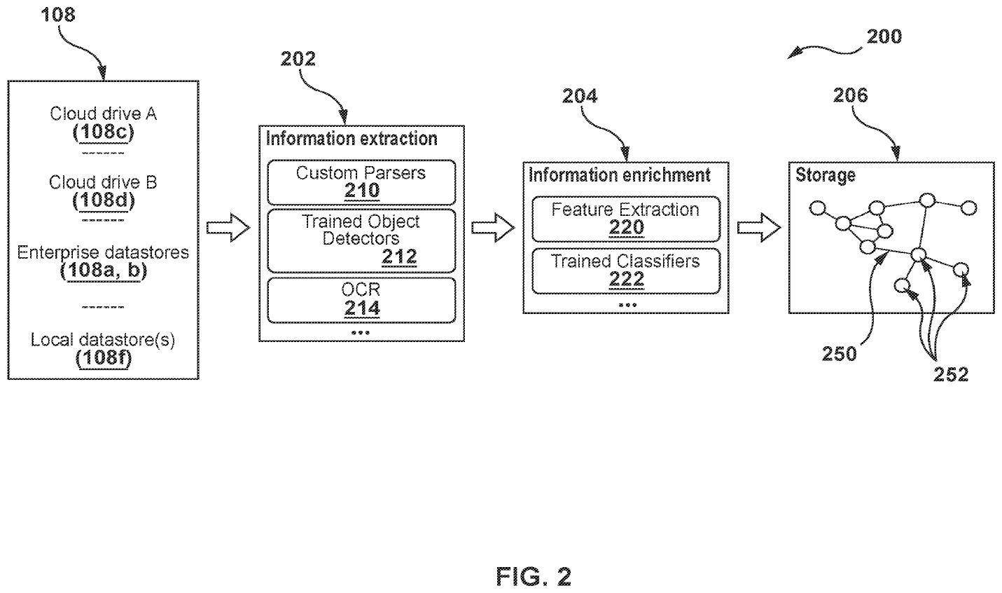

An example of a high-level process flow 200 of hierarchical searching in accordance with various aspects and examples of the disclosure is shown in FIG. 2. Documents to be searched, and/or to serve as objects of search requests, can be pulled from, pushed from, or otherwise obtained from any number and variety of sources 110, 108. In the example shown, for example, sources 108 can include a plurality of associated and/or independent document databases 108c,d, such as secure, enterprise-controlled cloud drives and/or open, public databases such as private or public data stores, websites, etc. Sources 108 can also, or in other implementations, include one or more local enterprise stores 108a,b, including for example either or both of secure enterprise data stores shared by multiple enterprise controllers 110 and local data store(s) associated with individual controllers 110.

At 202, documents received by a search engine system 100 and/or server 101 can parse documents received from source(s) 108 in order to extract content data of one or more types, e.g., data representing text, image, video, audio, and/or other data types, in order to identify various objects, features, etc., represented by the data, such as titles, sentences, paragraphs, text blocks, images, portions of images, etc., using custom parsers 210, object detector routines 212, and/or machine interpreting and learning techniques 214 such as optical character recognition, image recognition, etc, in order to enrich extracted data useful in describing or otherwise helpful in interpreting or identifying the content. Any suitable numbers and types of extraction routines or applications can be used, including for example custom parsers 210 comprising parsers adapted to interpret data in accordance with any desired types or numbers of protocols, including any desired text protocols. Examples can include protocols such as Embeddings from Language Models (ELMo), Bidirectional Encoder Representations from Transformers (BERT), Universal Language Model Fine-tuning for Text Classification (ULMFit), Word2vec, Global Vectors (GloVe) and other techniques for natural and other forms of language processing.

In some implementations, data sources 108 are or can be heterogenous in either or both of access and storage types 108a,b,c,d described above, and in structures or protocols used to represent the content objects or features. Thus application of system(s) 100, 101 to search documents can include multiple parsing processes of content data sets, in order to extract, interpret, and/or otherwise process content data comprised thereby.

When data objects representing various features have been extracted from a document data set, at 204 data records representing the extracted objects can enriched by the addition of information helpful to document search processes. Such extraction and enrichment can be accomplished using a variety of techniques. For example, machine-trained models 224 can be employed to tag textual data and/or data representing image objects. Records comprising embedded enriched information can be described as document feature or object vectors.

Finally, set(s) of object vectors associated with a parsed document can be stored, in the form of graph(s) 250 and/or other efficiently-searchable document hierarchies, indexes, levels, or other hierarchical representations of relationships between objects or features within the parsed documents in datastores 108a,b,c,d etc. Graphs 250 can be generated using vectors describing nodes 252 and associated with one another in document graph data sets for use in subsequent search processes.

A hierarchical search mechanism 100, related processes 200, can be based on document graphs 250, allowing richer search over representations learned by deep neural networks, which makes it possible to find content that is semantically similar to images, text, or complete documents. A very large number of searchable document data sets, each such set comprising at least one graph 250 representing one or more documents, can be stored for search purposes in one or more data stores 108 as described above.

Based on feature vectors represented within such stored graphs 250, nearest neighbors can be extracted based on any suitable similarity measure(s), including for example Euclidean distance algorithms. Such feature vectors can used to search over graphs 250 in different levels. Searching at different levels can allow extraction of information on the basis of feature vectors, thus nodes most similar to those identified through search requests can be retrieved, and similar documents or images can be identified for and/or presented to the requesting users, e.g., individuals operating search controller interface(s) 110.

The use of embeddings such as feature or object vectors offers a number of advantages, particularly when used to generate graphs based on multiple vectors. Non-limiting examples of such advantages include, for example, searching for full documents as well as document or information fragments, based on synonyms and based on image comparisons. The use of neural network and other machine learning techniques can be applied to enhance these capabilities.

In addition to, or in further examples, other variations of efficiently-searchable feature-hierarchy documents, including indexes, levels, or other hierarchical representations of relationships between objects or features within parsed documents can be used to execute hierarchical searches in accordance with the disclosure.

Responses to search requests received from search controller interfaces 110 can be presented in the form of ranked listings of responsive documents, optionally with the source(s) 108 of similar documents.

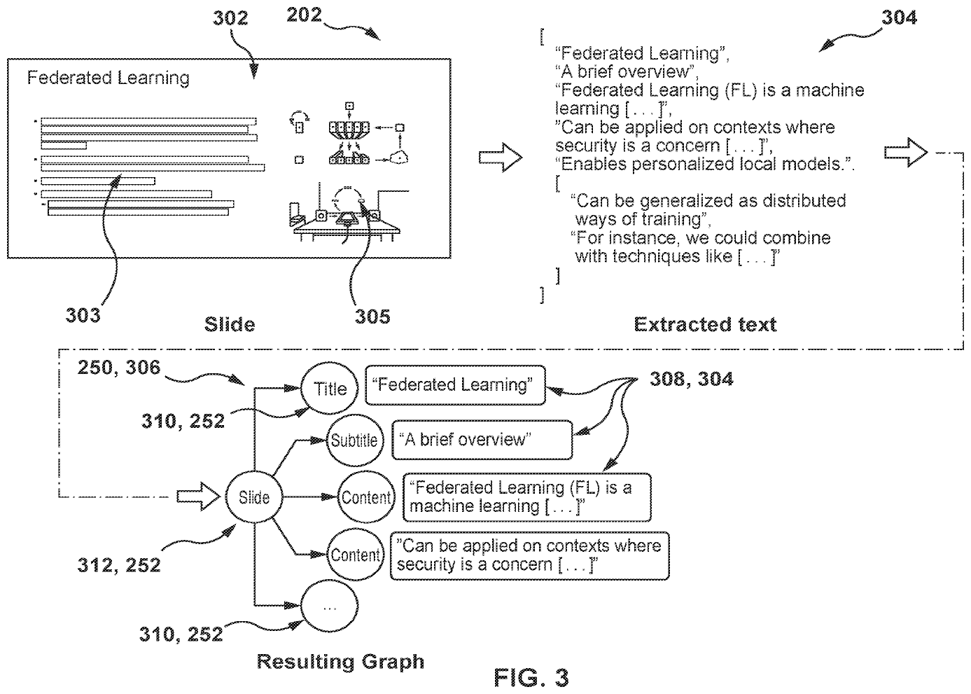

FIG. 3 provides a schematic representation of an example of an extraction process 202 suitable for use in implementing various aspects of the disclosure. At 302, in the example shown, an electronic document data set is provided, either as a search object or a potential search result, in the form of an electronic multi-media slide presentation comprising text and image(s) objects or features 303, 305. Using suitably-configured extraction routines or applications, such as ELMo, BERT, ELMFit, etc. the object 302 can be parsed and text features 304 “Federated Learning,” “A brief overview,” etc., can be extracted, and at 308 the extracted text features can be associated with enriching such as lowest-level information identifiers “Title,”, “Subtitle,” “Content.” When desired sets of such information have been extracted and associated with lowest-level identifiers such as “Title,” etc., to form graph or vector nodes, they can further be associated with higher-level identifier(s) 312 such as “Slide” or “Slide text,” etc., to form a graph or graph portion 250, based on characteristics such as text or font size, style, location, etc., associated by the engine 101 with various content types or objects.

Each node 310, 252 of a graph or graph portion 250, 306, can represent a content feature or object of a text portion 303 of the document 302. In the example shown in FIG. 3, nodes can include the title, subtitle, content (each sentence, or any desired portion(s) of a sentence can be designated a node), and images (each image or image portion can be designated as a node as well).

In some examples, the resulting extracted graph or graph portion data sets 250, 306 can be represented by two or more independent files: an adjacency matrix, comprising data representing graph topology, or indexable levels or relationships between nodes 252; and an attributes dictionary, representing attributes 304, 308 of the nodes 310, 312.

It will be understood that information extraction processes 202 can be specific to each document type since, as it can be desirable for search purposes for the information they contain to be structured differently. For example, in the example shown in FIG. 3, a document 302 can be associated with a corresponding document data set formatted in the Microsoft® Powerpoint® protocol for generation of a virtual slide, and parsing/extraction step 202 can comprise reading the Powerpoint® file to remove information 304, which can further be parsed into subsets corresponding to a title, subtitle, slide content, etc., as shown.

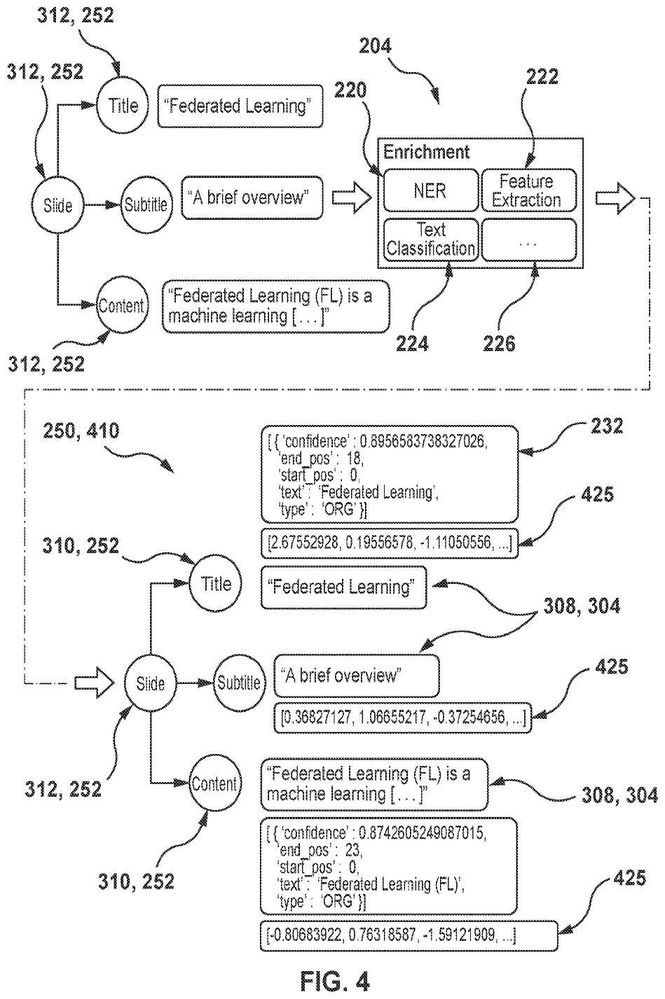

Extracted feature, object, or document graph sets 250, 306 corresponding to document data set(s) 302 can be enriched in accordance with various techniques 420, to generate enriched graph data sets 250, 410, as shown for example in FIG. 4. For example, for text fields 304, text features 308 can be extracted using a pre-trained word embedding method 220 such as ELMo, as described above. In FIG. 4, the feature vectors 310, 252 extracted in accordance with a protocol such as ELMo can be enriched using techniques 222 such as Named Entitity Recognition (NER) in order to generate tags 232 representing various levels of granularity, or document object or feature hierarchies (e.g., presentation, slides, content), and further classified in accordance with any previously known or machine-learned techniques or protocols 224. The resulting enriched document object data sets or graphs 250, 410 can represent different types of hierarchical content that match the given query in many ways.

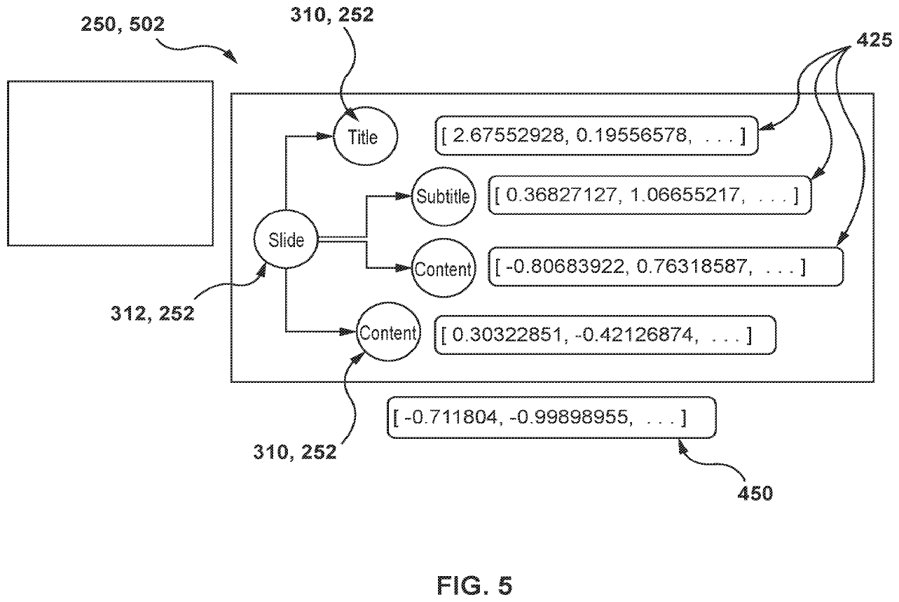

With the use of machine learning graph or index techniques 224 such as graph convolutional neural networks, an engine 102 can learn a representation for the entire graph 250, or for any or all of nodes 310, 312, 252 of the graphs 240, and map individual nodes 310 into vectors 425. Such machine learning procedures 224 can take into account the information of the features available in each node 310, 312, 252 or the nodes themselves and their relationships 250 in order to generate suitably unique vectors 425, 427. Thus, it is possible to generate graph or other representational data sets 250, 410 such as the one illustrated in FIG. 5.

Image features or objects 305 of document data sets 302 can be extracted and enriched using suitable techniques or protocols 220, 222, 224, and mapped into nodes and/or vectors 427, to generate complete document feature data sets, or graphs, 250, 502 such as that shown in FIG. 5, which can in turn be mapped into corresponding vectors 450.

Any or all of wholly- or partially-generated feature, object, and/or document graph data sets 250, 306, 410, 502 can be stored in any desired memory(ies) 108, 108a, 108b, 108c, 108d, 108f for later use in search processes and/or for archival or any other desired purposes. For example, known graph database solutions (such as Neo4j®) can be used, and database 108 can be capable of storing key-value pairs and blobs for extra information outside the graph (such as Neo4j®). By using known graph algorithms and techniques such as centrality, community detection, and path finding functions can be used. In other implementations, or in addition, optimized and or other special purpose applications, routines, or program can be implemented in accordance with the disclosure.

Databases 108 comprising stored graph, index, level, and/or other hierarchical data sets 250, 306, 410, 502 can be searched for documents, features, or objects, or combinations thereof, comprising data representing similar features or objects, using for example Euclidean and other metrics. To facilitate searching, various forms of maps or indexes can be generated by suitably-configured components of search system(s) 101. For example, Faiss or other libraries can be generated in order to increase the efficiency of searches by for example generating or facilitating generation of clusters of dense vectors. Then for example a search can be conducted by a search engine 102 on the basis of comparison of tags or embeddings 425, 427, 232.

Faiss and/or other indexes can be generated for each feature or object extraction or enrichment technique 220, 222, 224, employed. Using such indexes, queries based on specific embeddings or types of embeddings 425, 427, 232 can be used to retrieve the any desired number (K) of documents bearing the closest determined similarity, based on Euclidean distance or other similarity measures. The efficiency of such searches can result in better-balanced usage of GPUs, memory, and accuracy.

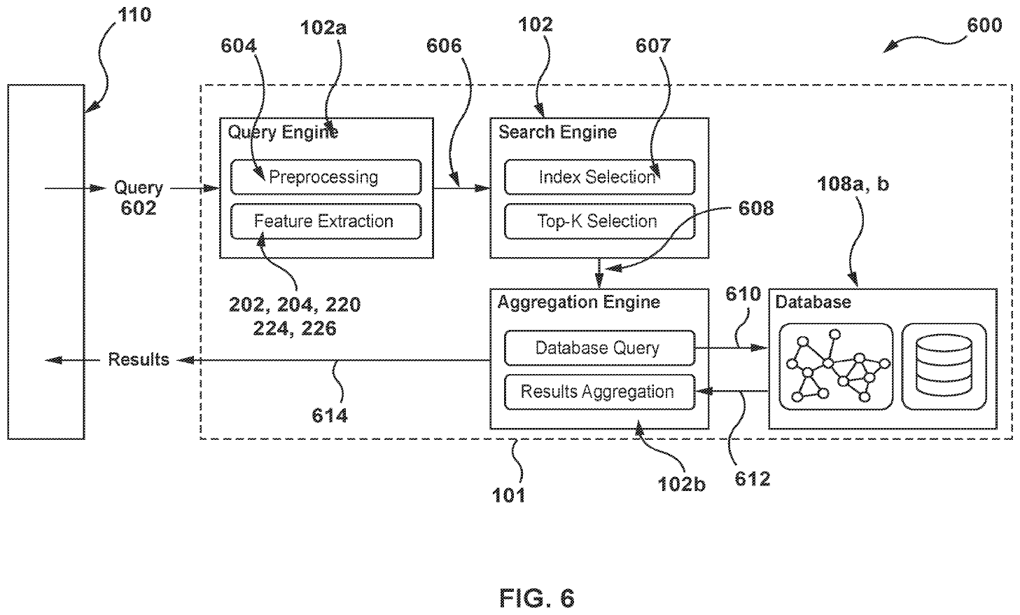

A representative search flow 600 is shown schematically in FIG. 6. At 602 a query in the form of a document search request data set comprising at least data associated with text, images, or other content to be searched for, and optionally indicating a number of search results to be returned, can be received from a search controller 110 and at 604 can preprocessed by a query engine 102a, which can interpret the request to identify it as a search request and route pertinent data for processing. At 220, 224, 226 feature extraction and enrichment routines can be applied, as described above.

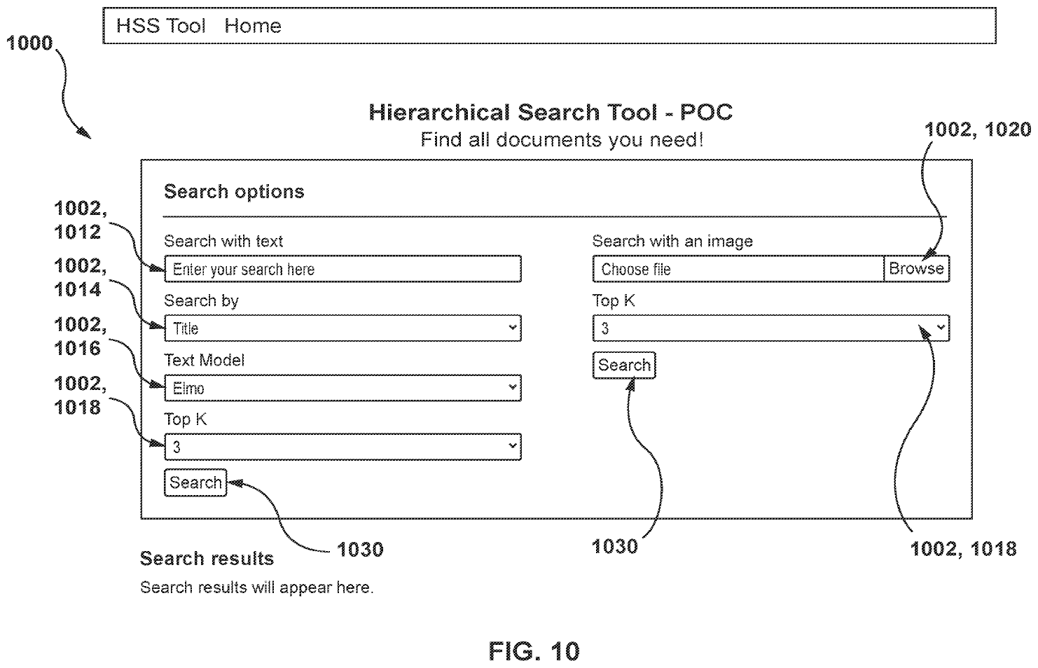

For example, a user of a search controller interface system 110 can be presented with a search request interface 1000 such as that shown in FIG. 10. By providing responsive input to interactive fields 1002, a user can designate any of a wide variety of criteria to be applied in the search process 600. For example, by using a keyboard or other input device, at 1012 a user can enter one or more text characters, such as keywords, phrases, etc., to be searched for in a given set of database(s) 108a,b,c,d,f; at 1014 the user can designate, by direct entry or use of a pull down menu, one or more classifications or levels of hierarchy, to be searched, such a document title, a subtitle, a section heading, or general text content; at 1016 a user can specify, by typing or other direct entry, or by use of a pull down menu one or more protocols, or sets of protocols, 222, 224, 226 to be used in extracting and enriching data, as described herein; at 1018 the user can specify a desired number of closest documents (‘hits’) to be returned by the search, in absolute numbers, in 10s, 100s, 1000s, or any other desired increments. At 1020, the user can in addition or in other implementations select or otherwise designate a data file 801 comprising data representing one or more images 803 to be searched for, by typing in the name of a file or using a ‘browse’ command icon to open a directory tree and navigate to a desired image file.

When the user is satisfied with his/her search criteria, at 602 he/she can select either ‘search’ command item 1030 to cause a search request data set comprising any data corresponding to the entered criteria to be routed to a search engine or system 101, 102, 102a.

At 606 the extracted and enriched data sets 250, 306, 410, 502 generated or recovered by query engine 102a on the basis of the received search request data set can be routed to a search engine 102 as described, and the search engine 102 can generate, select, or otherwise acquire a search index, and at 608 route a corresponding indexed search request data set to an aggregation engine 102b.

On receipt of the indexed search request data set, at 610 an aggregation engine 102 can generate and perform a suitably-configured data base query, using for example models 220, 224, 226 used in the enrichment phase, and at 612 retrieve, for example in accordance with any indexes designated or generated at 607, a desired number of nodes most similar to content designated by the input query, and a designated or available number of search results can be aggregated and placed in any desired format by generation of a document search results data set, and at 614 can be routed to the same or another document search interface controller 110.

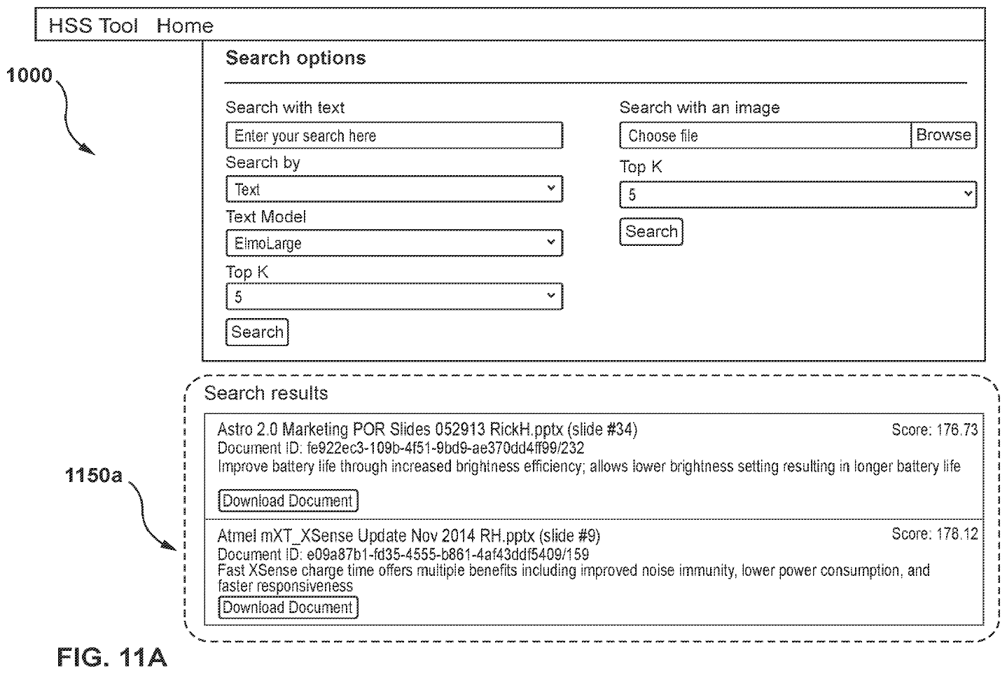

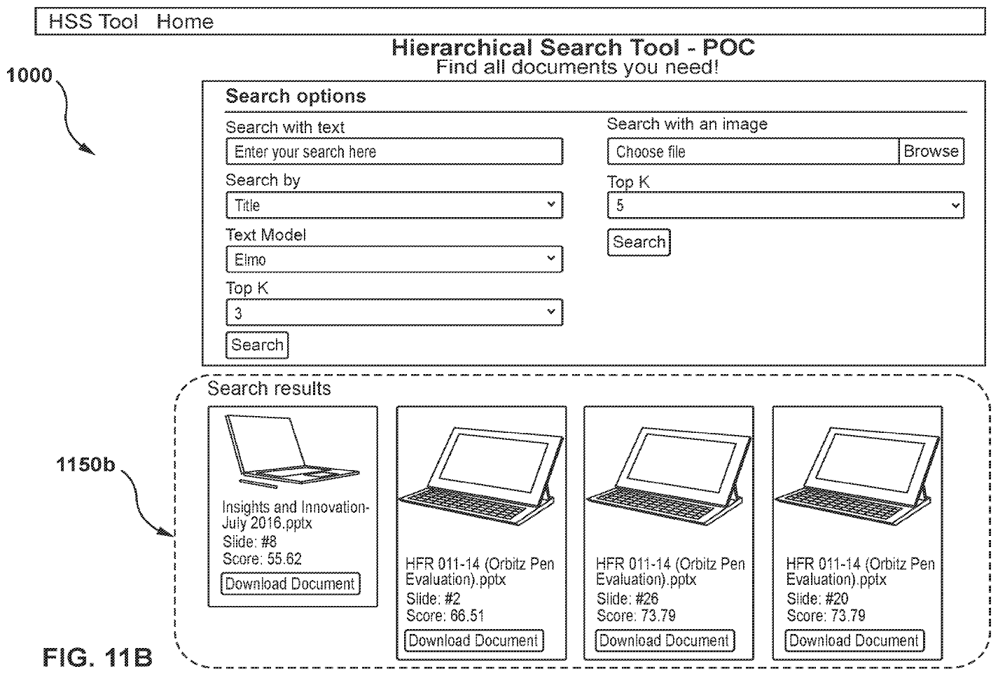

Example formats for presentation of information responsive to searches routed to search engines 101 by search controller interfaces 110 at 602 are shown at 1150a, 115b, respectively in FIGS. 11a and 11b. In FIG. 11a, a listing of responsive documents comprising relevant text portions is provided, while results provided at 1150b in FIG. 11b include relevant images from response documents.

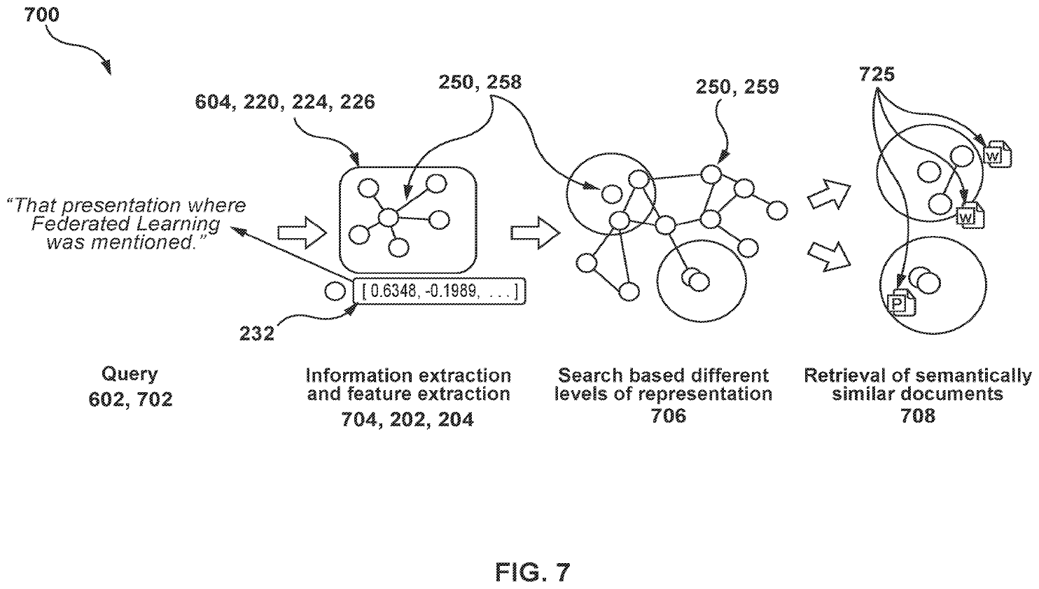

An example schematically illustrating a textual search query 700 is shown in FIG. 7. At 702-704 a search for a text string “that presentation where Federated Learning was mentioned” is requested, and a corresponding search instruction data set representing the text and any enrichments 250, 252, 425, 427, 450, etc., is generated and the enrichment phase to execute the feature extraction process 202, 204. The extracted and enriched features are then used at 706 to search over graphs 250 in databases 108 at different hierarchical levels 258, 259, 310, 312. Searching at different hierarchical levels 258, 259, 310, 312 enables at 708 retrieval of electronic documents 725 and/or other data sets, not only based on the designated text content “that presentation where Federated Learning was mentioned” itself, but also on individual elements of the text, such as “presentation,” “Federated Learning,” etc. Returned documents or data sets 725 can include text documents such as those generated by or compatible for use with word processors, image- or document-based documents in formats such as .jpg, .gif, .tif, .pdf, etc.

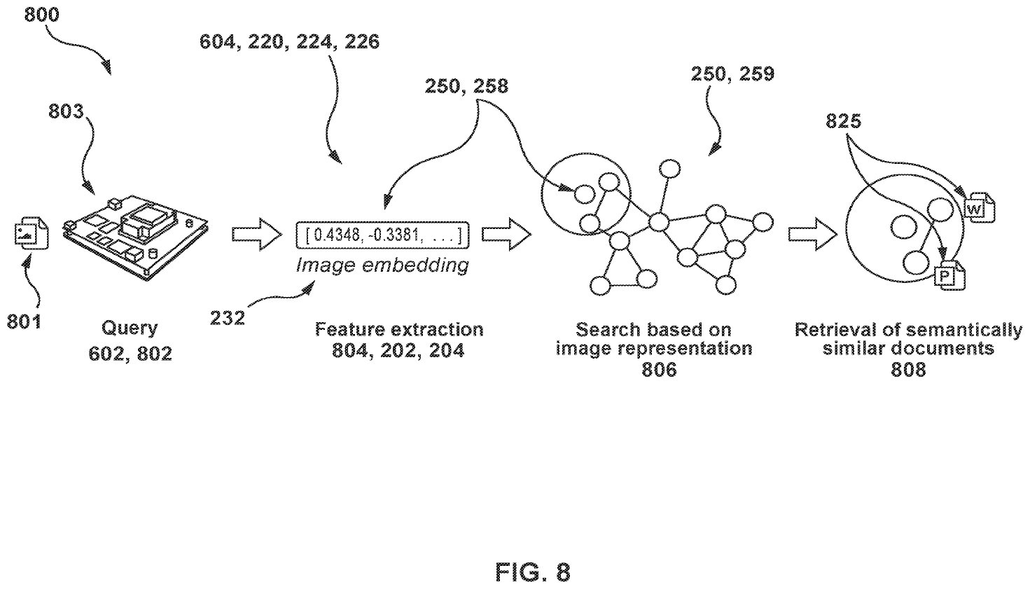

An example schematically illustrating an image search process 800 is shown in FIG. 8. In the image case 800, at 804 general-purpose feature extraction technique(s) 202, 204, 220, 224, 226, etc., can be used to generate search representations 250, 252, 425, 427, 450; and at 806, such representations can used to query information in the graph and, at 808 retrieve document data sets or associated data files 825 and/or corresponding graphs 250, 252 representing information similar to the image 803 represented by the data file 801, which can for example be formatted in accordance with the .jpg, .gif, .tif, or any other desired protocols used in connection with images identified as a part of the search request data set. Document data files 825 formatted for example in accordance with word processing, image presentation, and/or document processing controls can, for example, be returned or otherwise returned by the search.

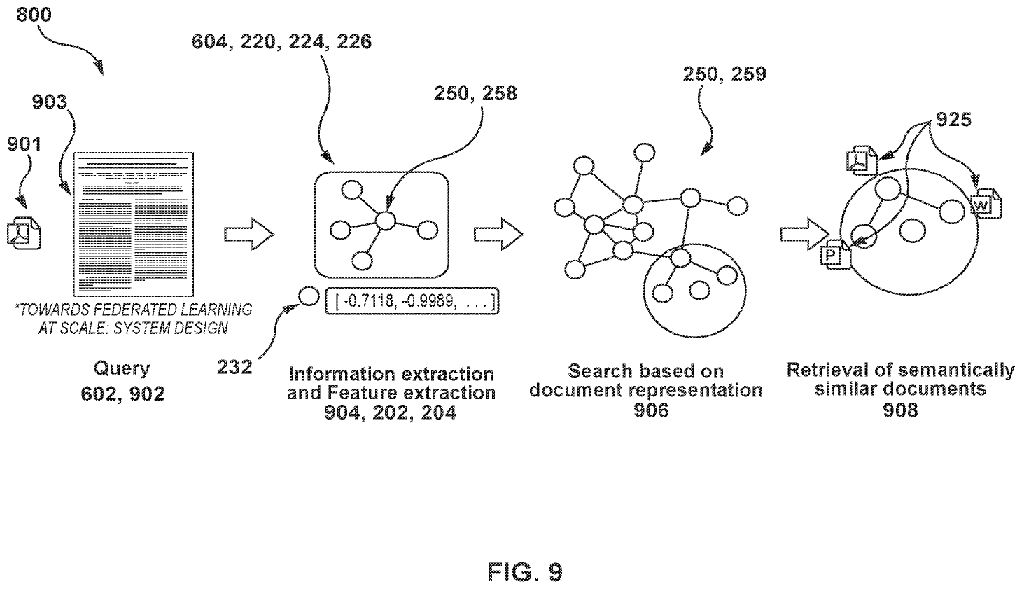

An example of a combined search process 900, involving both text and image data, is shown schematically in FIG. 9. In the example shown, at 902 a file 901 representing all or a portion of a mixed-media document 903 such as a report, a published scientific paper, a news account, etc., which might include text, images, links to videos, etc., is designated for use as an input query. As in the previous cases, at 904 process 900 can leverage multiple hierarchical levels 258, 259, 310, 312 of information represented within the document to retrieve data from the knowledge graph(s) 250, 258, 259. At 908 a desired number of most semantically-similar results can retrieved, such as documents 925 representing, presentations, reports, and other similar documents or document fragments.

It will be understood by those skilled in the relevant arts that the described examples are independent of hardware, software, and other component types, protocols, etc. Any components, software, protocols, etc., compatible with the purposes and concepts described or suggested herein will suffice.

Thus, it may be seen that in various aspects and examples the disclosure provides systems 100, methods 200, and corresponding computer-readable media for multi-modal hierarchical semantic search of electronic documents. Systems in accordance with the disclosure comprise search engine controllers 101, any desired numbers of search engine interface controllers 110, and persistent data stores 108 accessible by the search engine controllers. The controllers 101 are configured to parse searchable document data sets to extract document object data sets. Each document object data set can represent textual and/or image feature of the document. For each document object data sets the controller generates at least one enriched document object data set, and forms at least one of a document graph, index or other multi-level hierarchical logical structure. In response to search requests, the search controller compares document graphs or indexes to identify the most similar documents.

For example, in various aspects and examples the disclosure provides methods 200, 300, 400, 500, 600 for multi-modal hierarchical semantic search of electronic documents 725, 825, 925, etc., the methods performed by search engine controller(s) 101, 102, and/or 110 comprising logic circuits adapted to execute machine-readable instructions stored in the form of data representing coded electronic signals in memory accessible by the controller(s). Such methods can include accessing 602, by the search engine controller(s) 101, 102, 110 in accordance with the machine-readable instructions, a first searchable document data set 303, 305, 803, 903, etc., the first searchable document data set comprising data representing at least one of text rendered in accordance with a text protocol and an image rendered in accordance with an image protocol; parsing 202, 204, the first searchable document data set, in accordance with a plurality of protocols including at least the text protocol and the image protocol, to extract a plurality of document object data sets, each document object data set representing at least a portion of a textual or an image feature of the document; generating 220, 224, 226 for each of the plurality of document object data sets an enriched document object data set by associating the document object data set with a feature vector 232, 425, 427 corresponding to the feature represented by the respective document object data set; using the plurality of generated enriched document object data sets 308, 304, 232, 425, 427, generating a first searchable document vector index data set, or graph 250, 252 and storing 610 the first searchable document vector index data set in persistent storage 108a,b,c,d,f accessible by one or more of search engine controller(s) 101, 102, 110.

The disclosure further provides processes 600, 700, 800, 900 for accessing in the same or other persistent storage 108 a plurality of second searchable document vector index data sets 250, 252, each second searchable document vector graph data set comprising data representing a plurality of enriched document object data sets associated with a corresponding one of the plurality of second documents; comparing each of the plurality of second searchable document vector graph data sets 250, 252 to the first searchable document vector data set, and based on each comparison generating a corresponding document comparison value representing a similarity of the first and corresponding second searchable documents; and routing to at least one output device 102b, 110 a document search results data set comprising data representing the plurality of generated document comparison values.

It can further be seen that each of the plurality of second searchable document vector graph data sets 250, 252 and the first searchable document vector data set 250, 252 can associated with either or both of one or more document object data sets representing all or any portion(s) of a textual feature, an image feature, or any other features useful in electronic media, or any combinations thereof.

In the same and other aspects and examples, the disclosure provides systems 100, and controllers 101, for executing multi-modal hierarchical semantic searches 200 of electronic information stored in data stores 108, by parsing searchable document data sets 303, 305, 725, 825, 925 to extract document object data sets representing at least portion of textual and/or image features of the documents; generating for each of the document object data sets at least one enriched document object data set 304, 308, 232, 425, 427; comparing stored enriched document object data sets to search requests received from interface controllers 110, and route ranked listings 1150a,b of comparable documents to the requesting search controller interfaces.

Although the present disclosure has been described with reference to example examples, those skilled in the relevant arts will recognize that many variations and modifications may be made without departing from the spirit and scope of the claimed subject matter. For example, although different example examples may have been described as including features providing various benefits, it is contemplated that the described features may be interchanged or combined with one another in various examples. Except to the extent necessary or inherent in the processes themselves, no particular order to steps or stages of methods or processes described in this disclosure, including the Figures, is intended or implied.

1. A method for multi-modal hierarchical semantic search of electronic documents, comprising:
accessing, by a search engine controller, a first searchable document data set comprising data representing at least one of text and an image;
parsing the first searchable document data set to extract a plurality of document object data sets, each document object data set representing at least a portion of a textual or an image feature of the document;
generating for each of the plurality of document object data sets an enriched document object data set by associating the document object data set with a feature vector;
using the plurality of generated enriched document object data sets, generating a first searchable document vector index data set and storing the first searchable document vector index data set in persistent storage;
accessing in the same or other persistent storage a plurality of second searchable document vector index data sets, each second searchable document vector graph data set representing a plurality of enriched document object data sets associated with a corresponding one of the plurality of second documents;
comparing each of the second searchable document vector graph data sets to the first searchable document vector data set to generate, with respect to each second searchable document vector graph data set at least one document comparison value; and
routing to at least one output device a search results data set.

2. The method of claim 1, wherein each of the plurality of second searchable document vector graph data sets and the first searchable document vector data set is associated with a document object data set representing a portion of a textual feature.

3. The method of claim 1, wherein each of the plurality of second searchable document vector graph data sets and the first searchable document vector data set is associated with a document object data set representing a portion of an image feature.

4. The method of claim 1, wherein each of the plurality of second searchable document vector graph data sets and the first searchable document vector data set is associated with document object data sets representing portions of both textual and image features.

5. A system for multi-modal hierarchical semantic search of electronic information, comprising a search engine controller, at least one search engine interface controller, and at least one persistent data store accessible by the search engine controller, the data store comprising stored computer-readable media configured to cause the search engine controller to:
parse a first searchable document data set to extract a plurality of document object data sets, each document object data set representing at least a portion of a textual or an image feature of the document;
generate for each of the plurality of document object data sets at least one enriched document object data set;
using the plurality of generated enriched document object data sets, generate a first searchable document hierarchy data set and store the first searchable document hierarchy data set in persistent storage accessible by the at least one search engine controller;
access, in the same or other persistent storage, a plurality of second searchable document hierarchy data sets, each second searchable document hierarchy data set representing a plurality of enriched document object data sets associated with a corresponding one of the plurality of second documents;
compare each of the second searchable document hierarchy data sets to the first searchable document hierarchy data set and generate with respect to each second searchable document hierarchy data set a document comparison value; and
route at least a ranked list of comparable documents to the at least one search controller interface, based at least partly on the generated document comparison values.

6. The system for multi-modal hierarchical semantic search of electronic information of claim 5, wherein each of the plurality of second searchable document hierarchy data sets and the first searchable document hierarchy data set is associated with a document object data set representing a portion of a textual feature.

7. The system for multi-modal hierarchical semantic search of electronic information of claim 5, wherein each of the plurality of second searchable document hierarchy data sets and the first searchable document hierarchy data set is associated with a document object data set representing a portion of an image feature.

8. The system for multi-modal hierarchical semantic search of electronic information of claim 5, wherein each of the plurality of second searchable document hierarchy data sets and the first searchable document hierarchy data set is associated with document object data sets representing portions of both textual and image features.

9. The system for multi-modal hierarchical semantic search of electronic information of claim 5, wherein the first and second document hierarchy data sets comprise document graph data sets.

10. The system for multi-modal hierarchical semantic search of electronic information of claim 5, wherein the first and second document hierarchy data sets comprise document index data sets.

11. The system for multi-modal hierarchical semantic search of electronic information of claim 5, wherein the first and second document hierarchy data sets comprise document level data sets.

12. Stored computer-readable media configured, when executed by at least one controller of a multi-modal hierarchical semantic search system, to cause the at least one controller to:
parse a first searchable document data set to extract a plurality of document object data sets, each document object data set representing at least a portion of a textual or an image feature of the document;
to generate for each of the plurality of document object data sets at least one enriched document object data set;
using the plurality of generated enriched document object data sets, generate a first searchable document hierarchy data set and store the first searchable document hierarchy data set in persistent storage accessible by the at least one controller;
access, in the same or other persistent storage, a plurality of second searchable document hierarchy data sets, each second searchable document hierarchy data set representing a plurality of enriched document object data sets associated with a corresponding one of the plurality of second documents;
compare each of the second searchable document hierarchy data sets to the first searchable document hierarchy data set to generate, with respect to each second searchable document hierarchy data set a document comparison value; and
route at least a ranked list of comparable documents to the at least one search controller interface, based at least partly on the generated document comparison values.

13. The computer-readable media of claim 12, wherein each of the plurality of second searchable document hierarchy data sets and the first searchable document hierarchy data set is associated with a document object data set representing a portion of a textual feature.

14. The computer-readable media of claim 12, wherein each of the plurality of second searchable document hierarchy data sets and the first searchable document hierarchy data set is associated with a document object data set representing a portion of an image feature.

15. The computer-readable media of claim 12, wherein each of the plurality of second searchable document hierarchy data sets and the first searchable document hierarchy data set is associated with document object data sets representing portions of both textual and image features.
